(19) United States
(12) Patent Application Publication
(10) Pub. No.: US 2001/0003760 A1
(43) Pub. Date: Jun. 14, 2001

(54) Additive composition for paper making

(75) Inventor: Kari Luukkonen, Raisio (FI)

Correspondence Address: Burton A. Amernick, POLLOCK, VANDE SANDE & PRIDDY, P.O. Box 19088, Washington, DC, 20036-3425, US

(73) Assignee: RAISIO CHEMICALS LTD., Raisio (FI)

(21) Appl. No.: 09/756,758

(22) Filed: Jan. 10, 2001

Related U.S. Application Data
(63) Continuation-in-part of application No. PCT/FI99/00602, filed on Jul. 7, 1999.

(30) Foreign Application Priority Data
Jul. 10, 1998 (FI) 981586
Feb. 5, 1999 (FI) 990228

(51) Int. Cl. C08K 5/1545; C08K 5/053; C08F 8/00

(52) U.S. Cl. 524/47; 525/54.24

(57) ABSTRACT

The object of the present invention is an additive composition for paper making which is added to the pulp prior to web formation in order to increase the wet strength of the web. The basic component of the composition is a component made from starch, which to its molecular weight has been thinned to a viscosity level of 10 to 400 (5%, 60° C., Brookfield) which by solution cationizing using a quaternary nitrogen compound is cationized to a charge of <4 mEkv/g, the composition containing at least one additional component selected from

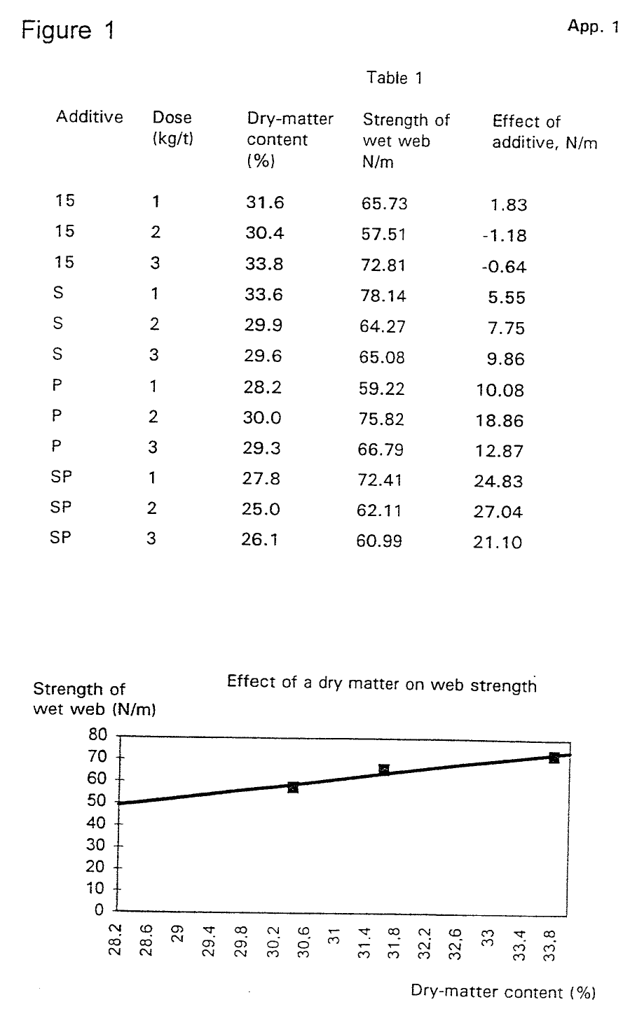

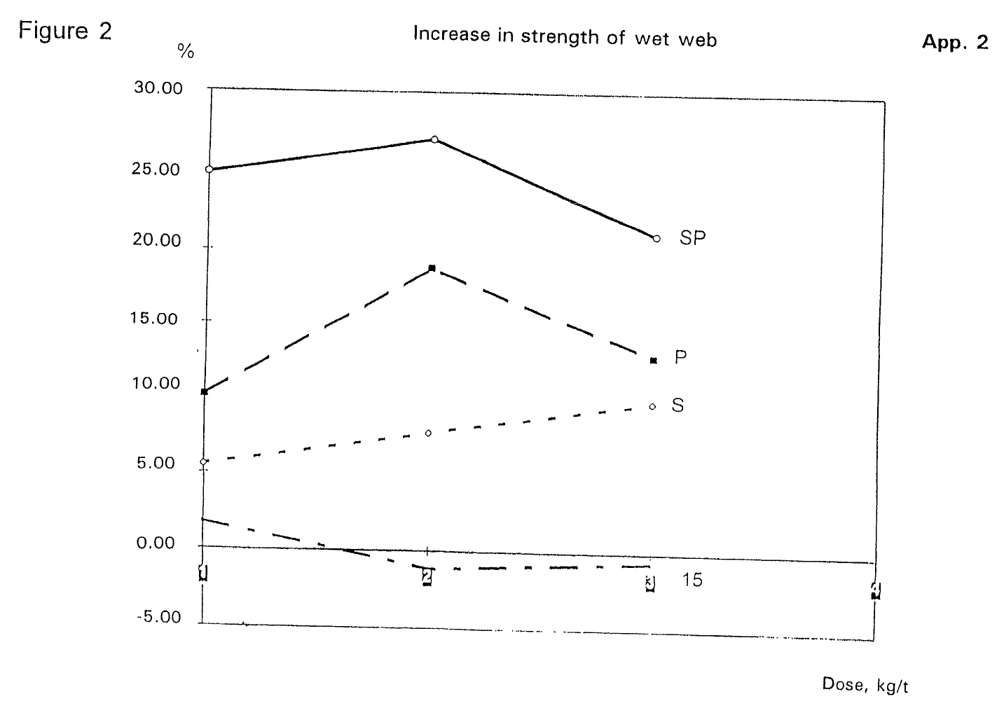

1) a starch-based polymer dispersion which contains starch and a monomeric graft copolymer, providing a polymer having a film formation temperature of −50 to 200° C., and

2) polyamide epichlorhydrin resin (PAAE).

The invention concerns an additive composition for paper making to be added to fiber pulp in a step preceding the web formation step of the paper making. The additive improves essentially the strength of the wet web, which is important as regards the wet part of the paper machine, because the improved strength diminishes breaks and makes the use of higher machine speeds possible.

The basic component in the additive composition is starch, which has been modified to better meet the requirements of the invention, by reduction of its molecule size and reacting the same with a suitable nitrogen compound in order to accomplish a proper cationic charge for the starch.

The reduction of the molecule size has been performed preferably using oxidation, such as peroxide oxidation. The reduction in molecule size is preferably effected so that a starch suspension with a consistency of 5% possesses a viscosity of 10 to 400 mPas (Brookfield), preferably 100 to 400 mPas, and most preferably 100 to 200 mPas at a temperature of 6020 C. These values can be achieved for instance using a hydrogen peroxide amount of about 0.02 to 0.3% based on the dry-matter of the starch in mild alkaline reaction conditions. The degree of degradation aimed at depends also on the cationic charge of the end product, because an increase in the cationic charge has a lowering effect on the viscosity of the end product. A dependency prevails also between the molecule size and the cationic charge, which has an influence on the behaviour of starch on paper machine.

Starch, which is modified to a proper viscosity level is then processed with a quaternary nitrogen compound in conformity with the invention so, that it possesses a cationic charge in the range of <4, preferably 0.36 to 2.5, more preferably 0.72 to 1.10 mEq/g. The product is made preferably using a solution cationizing process where the starch is introduced into the cationizing process in granular form, and the process conditions are selected to solubilize the starch totally during the process. Essential parameters for the process in this respect are the percentage of the starch to be cationized, a suitable alkalinity, and an elevated temperature. A suitable alkaline (NaOH) charge is about 1.5-3% of the dry-matter of the starch, and a suitable temperature is about 60 to 80° C. The dry-matter content of the reation mixture should preferably be above 50%, which i.a. gives a good yield for the end product. A suitable quaternary cationizing chemical is 2,3-epoxypropyl-trimethylammonium chloride, which is to used in an amount of about 10 to 40% of the starch.

In addition to the basic component the additive composition contains at least one further component, by means of which the properties of the basic component, which are advantageous as such to the paper making process, can be modified in a direction towards the desired effect, and/or provide a composition, in which the synergistic effect of the components gives properties clearly different from the properties of the basic component.

One possible further component is a polymer dispersion based on starch, and containing a graft copolymer of starch and monomers, subsequently called the graft component. This component contains, calculated as dry weight of the product, the following

a) 5 to 50% starch with a degree of substitution (DS), relative to the cationic or anionic substituents, of from 0.01 to 1, and an intrinsic viscosity of >1.0 dl/g, when cationized and/or anionized,

b) 50 to 95% of a monomer mixture containing at least one vinyl monomer, providing a polymer having a film formation temperature of −50 to 200° C. preferably of 0 to 100° C., more preferably of 0 to 70° C., most preferably of 10 to 50° C., and

c) water.

The preferred substitution of the starch graft component in the above further component a) is accomplished to provide a cationic substitution within the mentioned range.

The detailed composition of the said graft component and the preparation thereof is disclosed in publication WO 00/46264 based on Finnish patent application No 990229, and entitled “Polymer dispersion and method to produce the same”.

Another alternative component for the additive composition is polyamide epichlorhydrin resin (PAAE) used as a wet strength resin in the paper industry, which in the following will be called the resin component.

The additive composition can be made from these components alternatively depending on the intended use, so that the either the graft or the resin component, or both, are added to the basic component.

The quantitative ratios between the basic component and the graft component can be chosen in the range of 30 to 70/70 to 30%, preferably 40 to 60/60 to 40%. A composition containing equal parts is especially preferred.

Correspondingly the quantitative ratios between the basic component and the resin component can vary in the ranges 25 to 75/75 to 25%, preferably 40 to 60/60 to 40%. Also in this case a composition containing equal parts is especially preferred.

In case the additive is composed of all three components, the proportions of the components can be within the ranges:

| | | |
|---|---|---|
| basic component, | 10 to 50%, preferably | 20 to 40% |
| graft component | 10 to 50%, preferably | 20 to 40% |
| resin component | 10 to 50%, preferably | 20 to 40% |

so that the composition forms 100%.

It has been observed that advantageous results can be obtained with the additive composition according to the invention for example so that the basic component together with the graft component has led to improved retention on the paper machine. It has been observed that the printing characteristics of a paper made using this additive compostion have improved, as also improved paper strength characteristics and improved dimensional stability have been observed.

The basic component and the resin component decrease the Tinting tendency of the manufactured paper. Improved retention and improved dewatering have been observed as advantageous effects in the manufacturing stage. It has also been observed that the additive has fixating properties, which is of importance from the point of view of removing detrimental substances from the circulation.

It has been observed that the strength of the wet stage web has increased especially with an additive composition which in addition to the basic component includes both a graft and a resin component.

The operability of the invention is illustrated with the following example.

### EXAMPLE 1

Newsprint was made on a pilot scale paper machine, the fiber stock of which consisted of 50% pressure groundwood and 50% thermomechanical pulp, which had been bleached with dithionite. In the test run, additive composition in an amount of 1, 2 and 3 kg/ton paper (dry/dry) was added to the pulp prior to web formation.

The basic component in the additive composition used in the tests was thinned starch, which had been cationized using 25%, calculated from the amount of starch, of the cationizing chemical 2,3-epoxypropyl-trimethylammonium chloride.

As a second additional component, graft component, to be combined with this basic component a composition was used which contains 20% starch, having a cationic degree of substitution of approximately 0.05 and an intrinsic viscosity of 3 to 15 dl/g, 19% acrylonitrile, 30% butyl acrylate, 31% styrene, and water.

As a second additional component, the resin component, polyamide epichlorhydrin resin (PAAE) was used.

The test results obtained are given in the table I in appendix 1 hereto.

The reference in the test was an additive, which was the same as the basic component of the additive composition according to the invention, and is indicated in the table with the symbol “15”.

The symbol “S” in the table means an additive composition containing 50% basic component 15 and 50% graft component. The symbol “P” in turn means an additive composition containing 50% of basic component and 50% of resin component. The symbol “SP” in turn means a composition containing ⅓ of basic component, ⅓ of graft component and ⅓ of resin component.

The strength of the wet web was measured and based thereon the effect of the additive component on the strength was derived, by taking into account the effect of the dry-matter content of the web on the strength of the web. The relationship between the dry matter content of the web and the strength is disclosed in the graph in connection with the table I.

Based on the test results it can be deduced that all the compositions S, P and SP increased the strength of the wet web, of these the composition SP the best.

The development of the strength of the wet web as obtained from the test results is also disclosed as a graph as according to appendix 2. The symbols 15, S, P and SP correspond to the compositions defined above.

1. An additive composition for paper making to be added to the pulp prior to web formation, containing as its basic component a component, which is made from starch, which to its molecular weight has been thinned to a viscosity level of 10 to 400 (5%, 60° C., Brookfield), and to its cationic charge has been cationized by solution cationizing using a quaternary nitrogen compound to a charge of <4 mEq/g, and further at least one additional component selected from
1) a starch-based polymer dispersion which contains starch and a monomeric graft copolymer, which comprises, calculated form the dry-matter content of the product:
a) 5 to 50% starch with a degree of substitution (DS), relative to the cationic substituents, of from 0.01 to 1, and an intrinsic viscosity of >1.0 dl/g, when cationized,
b) 50 to 95% of a monomer mixture containing at least one vinyl monomer,
and providing a polymer having a film formation temperature of −50 to 200° C., and
c) water. 2) polyamide epichlorhydrin resin (PAAE).

2. The additive composition according to claim 1, wherein the basic component starch to its molecular weight has been thinned to a viscosity level of 100 to 400 mPas (5%, 60° C., Brookfield).

3. The additive composition according to claim 1 or 2, wherein the basic component starch to its molecular weight has been thinned to a viscosity level of 100 to 200 mPas (5%, 60° C., Brookfield).

4. The additive composition according to any of the preceding claims 1 to 3, wherein the basic component starch has been cationized to a charge level of 0.36 to 2.5 mEq/g.

5. The additive composition according to any of the preceding claims 1 to 3, wherein the basic component starch has been cationized to a charge level of 0.72 to 1.10 mEq/g.

6. The additive composition according to any of the preceding claims 1 to 5, wherein the film formation temperature of the polymer of the component 1) is in the range of 0 to 70° C.

7. The additive composition according to any of the preceding claims 1 to 6, with quantitative ratios between the basic component and the component 1) in the range of 30 to 70/70 to 30%.

8. The additive composition of claim 7 with quantitative rations between the basic component and the component 1) in the range of 40 to 60/60 to 40%.

9. The additive composition of claim 7 with equal quantitative rations between the basic component and the component 1).

10. The additive composition according to any of the preceding claims 1 to 6, wherein the quantitative ratios between the basic component and component 2) are in the range of 25 to 75/75 to 25%.

11. The additive composition according to any of the preceding claims 1 to 6, wherein the quantitative ratios between the basic component and component 2) are in the range of 40 to 60/60 to 40%.

12. The additive composition according to any of the preceding claims 1 to 6, with equal quantitative ratios between the basic component and component 2).

13. The additive composition according to any of the preceding claims 1 to 6, with quantitative ratios between the basic component and the components 1) and 2) in the range of:

| | | |
|---|---|---|
| basic component, | 10 to 50%, preferably | 20 to 40% |
| graft component | 10 to 50%, preferably | 20 to 40% |
| resin component | 10 to 50%, preferably | 20 to 40% |

so that the composition forms 100%.

14. The additive composition according to claim 13, with quantitative ratios between the basic component and the components 1) and 2) in the range of:

| | |
|---|---|
| basic component, | 20 to 40% |
| graft component | 20 to 40% |
| resin component | 20 to 40% |

so that the composition forms 100%.

15. A method for increasing the strength of a wet paper web wherein an additive composition of any of the preceding claims 1 to 14 is added to the fiber suspension before the web formation.

16. The method according to claim 15, wherein the additive composition is added to the fiber suspension in an amount of 1.0 to 3.0 kg per each fiber ton on dry basis.

17. A use of the additive according to any of the preceding claims 1 to 14 for increasing the strength of the wet web in manufacturing of paper.

18. An additive composition for paper making to be added to the pulp prior to web formation, containing as its basic component a component, which is made from starch, which to its molecular weight has been thinned to a viscosity level of 10 to 400 (5%, 60° C., Brookfield), and to its cationic charge has been cationized by solution cationizing using a quaternary nitrogen compound to a charge of <4 mEq/g, and further at least one additional component selected from
1) a starch-based polymer dispersion which contains starch and a monomeric graft copolymer, which comprises, calculated form the dry-matter content of the product:
a) 5 to 50% starch with a degree of substitution (DS), relative to the anionic substituents, of from 0.01 to 1, and an intrinsic viscosity of >1.0 dl/g, when substituted,
b) 50 to 95% of a monomer mixture containing at least one vinyl monomer,
and providing a polymer having a film formation temperature of −50 to 200° C., and
c) water.
2) polyamide epichlorhydrin resin (PAAE).

19. The additive composition according to claim 18, wherein the basic component starch to its molecular weight has been thinned to a viscosity level of 100 to 400 mPas (5%, 60° C., Brookfield).

20. The additive composition according to claim 18 or 19, wherein the basic component starch to its molecular weight has been thinned to a viscosity level of 100 to 200 mPas (5%, 60° C., Brookfield).

21. The additive composition according to any of the preceding claims 18 to 20, wherein the basic component starch has been cationized to a charge level of 0.36 to 2.5 mEq/g.

22. The additive composition according to any of the preceding claims 18 to 20, wherein the basic component starch has been cationized to a charge level of 0.72 to 1.10 mEq/g. (5)

23. The additive composition according to any of the preceding claims 18 to 22, wherein the film formation temperature of the polymer of the component 1) is in the range of 0 to 70° C.

24. The additive composition according to any of the preceding claims 18 to 23, with quantitative ratios between the basic component and the component 1) in the range of 30 to 70/70 to 30%.

25. The additive composition of claim 24 with quantitative rations between the basic component and the component 1) in the range of 40 to 60/60 to 40%.

26. The additive composition of claim 24 with equal quantitative rations between the basic component and the component 1).

27. The additive composition according to any of the preceding claims 18 to 23, wherein the quantitative ratios between the basic component and component 2) are in the range of 25 to 75/75 to 25%. (10)

28. The additive composition according to any of the preceding claims 18 to 23, wherein the quantitative ratios between the basic component and component 2) are in the range of 40 to 60/60 to 40%.

29. The additive composition according to any of the preceding claims 18 to 23, with equal quantitative ratios between the basic component and component 2).

30. The additive composition according to any of the preceding claims 18 to 23, with quantitative ratios between the basic component and the components 1) and 2) in the range of:

| | | |
|---|---|---|
| basic component, | 10 to 50%, preferably | 20 to 40% |
| graft component | 10 to 50%, preferably | 20 to 40% |
| resin component | 10 to 50%, preferably | 20 to 40% |

so that the composition forms 100%.

31. The additive composition according to claim 30, with quantitative ratios between the basic component and the components 1) and 2) in the range of:

| | |
|---|---|
| basic component, | 20 to 40% |
| graft component | 20 to 40% |
| resin component | 20 to 40% |

so that the composition forms 100%.

32. A method for increasing the strength of a wet paper web wherein an additive composition of any of the preceding claims 18 to 31 is added to the fiber suspension before the web formation.

33. The method according to claim 32, wherein the additive composition is added to the fiber suspension in an amount of 1.0 to 3.0 kg per each fiber ton on dry basis.

34. A use of the additive according to any of the preceding claims 18 to 31 for increasing the strength of the wet web in manufacturing of paper.

35. An additive composition for paper making to be added to the pulp prior to web formation, containing as its basic component a component, which is made from starch, which to its molecular weight has been thinned to a viscosity level of 10 to 400 (5%, 60° C., Brookfield), and to its cationic charge has been cationized by solution cationizing using a quaternary nitrogen compound to a charge of <4 mEq/g, and further at least one additional component selected from
1) a starch-based polymer dispersion which contains starch and a monomeric graft copolymer, which comprises, calculated form the dry-matter content of the product:
a) 5 to 50% starch with a degree of substitution (DS), relative to the cationic and anionic substituents, of from 0.01 to 1, and an intrinsic viscosity of >1.0 dl/g, when substituted,
b) 50 to 95% of a monomer mixture containing at least one vinyl monomer,
and providing a polymer having a film formation temperature of −50 to 200° C., and
c) water.
2) polyamide epichlorhydrin resin (PAAE).

36. The additive composition according to claim 35, wherein the basic component starch to its molecular weight has been thinned to a viscosity level of 100 to 400 mPas (5%, 60° C., Brookfield).

37. The additive composition according to claim 35 or 36, wherein the basic component starch to its molecular weight has been thinned to a viscosity level of 100 to 200 mPas (5%, 60° C., Brookfield).

38. The additive composition according to any of the preceding claims 35 to 37, wherein the basic component starch has been cationized to a charge level of 0.36 to 2.5 mEq/g.

39. The additive composition according to any of the preceding claims 35 to 37, wherein the basic component starch has been cationized to a charge level of 0.72 to 1.10 mEq/g.

40. The additive composition according to any of the preceding claims 35 to 38, wherein the film formation temperature of the polymer of the component 1) is in the range of 0 to 70° C.

41. The additive composition according to any of the preceding claims 35 to 40, with quantitative ratios between the basic component and the component 1) in the range of 30 to 70/70to 30%.

42. The additive composition of claim 41 with quantitative rations between the basic component and the component 1) in the range of 40 to 60/60 to 40%.

43. The additive composition of claim 41 with equal quantitative rations between the basic component and the component 1).

44. The additive composition according to any of the preceding claims 35 to 40, wherein the quantitative ratios between the basic component and component 2) are in the range of 25 to 75/75 to 25%.

45. The additive composition according to any of the preceding claims 35 to 40, wherein the quantitative ratios between the basic component and component 2) are in the range of 40 to 60/60 to 40%.

46. The additive composition according to any of the preceding claims 35 to 40, with equal quantitative ratios between the basic component and component 2).

47. The additive composition according to any of the preceding claims 35 to 40, with quantitative ratios between the basic component and the components 1) and 2) in the range of:

| | | |
|---|---|---|
| basic component, | 10 to 50%, preferably | 20 to 40% |
| graft component | 10 to 50%, preferably | 20 to 40% |
| resin component | 10 to 50%, preferably | 20 to 40% |

so that the composition forms 100%.

48. The additive composition according to claim 47, with quantitative ratios between the basic component and the components 1) and 2) in the range of:

| | |
|---|---|
| basic component, | 20 to 40% |
| graft component | 20 to 40% |
| resin component | 20 to 40% |

so that the composition forms 100%.

49. A method for increasing the strength of a wet paper web wherein an additive composition of any of the preceding claims 35 to 48 is added to the fiber suspension before the web formation.

50. The method according to claim 49, wherein the additive composition is added to the fiber suspension in an amount of 1.0 to 3.0 kg per each fiber ton on dry basis.

51. A use of the additive according to any of the preceding claims 35 to 48 for increasing the strength of the wet web in manufacturing of paper.
